(19) United States
(12) Patent Application Publication
(10) Pub. No.: US 2024/0262996 A1
(43) Pub. Date: Aug. 8, 2024

(54) MOLDING MATERIAL

(71) Applicant: SEIKO EPSON CORPORATION, Tokyo (JP)

(72) Inventors: Tomohiro FUJITA, Matsumoto (JP); Masaaki AOTA, Suwa (JP); Takashi HIRAIWA, Fujimi-machi (JP)

(21) Appl. No.: 18/427,917

(22) Filed: Jan. 31, 2024

(30) Foreign Application Priority Data
Feb. 2, 2023 (JP) 2023-014552

(51) Int. Cl. C08L 23/12

(52) U.S. Cl. CPC C08L 23/12; C08L 2205/16

(57) ABSTRACT

A molding material of the present disclosure includes cellulose fibers, a binder, and urethane fibers. The content of the cellulose fibers in the molding material of the present disclosure is preferably 2% by mass or more and 40% by mass or less. The average length of the cellulose fibers is preferably less than 3 mm. The content of the binder in the molding material of the present disclosure is preferably 35% by mass or more and 94% by mass or less. The content of the urethane fibers in the molding material of the present disclosure is preferably 2% by mass or more and 40% by mass or less.

The present application is based on, and claims priority from JP Application Serial Number 2023-014552, filed Feb. 2, 2023, the disclosure of which is hereby incorporated by reference herein in its entirety.

### BACKGROUND

### 1. Technical Field

The present disclosure relates to a molding material.

### 2. Related Art

A molded body produced by using a material including cellulose fibers and a resin has been heretofore known. For example, Japanese Patent No. 7097521 suggests a cellulose fiber-reinforced thermoplastic resin molded body containing a thermoplastic resin, cellulose fibers, and organic fibers different from the cellulose fibers, for the purpose of providing a molded body in which a sufficiently high bending elastic modulus (stiffness) and excellent impact strength are both achieved.

Although improvement in impact strength is observed in the cellulose fiber-reinforced thermoplastic resin molded body described in Japanese Patent No. 7097521, fibers thereof significantly fall off the cellulose fiber-reinforced thermoplastic resin molded body. Therefore, there has been the following problem: the cellulose fiber-reinforced thermoplastic resin molded body described in Japanese Patent No. 7097521 is not suitable for those used in an environment in which dust generation or the like is problematic, more specifically, for a member having a fluid path, a member disposed around such a member, an ink cartridge, various containers, and various fixtures, for example.

### SUMMARY

The present disclosure has been made in order to solve the above problem and can be implemented as the following application example.

A molding material according to an application example of the present disclosure includes cellulose fibers, a binder, and urethane fibers.

### DESCRIPTION OF EMBODIMENTS

A preferable embodiment of the present disclosure will be described in detail below.

### [1] Molding Material

First, a molding material of the present disclosure will be described. The molding material of the present disclosure includes cellulose fibers, a binder, and urethane fibers.

Such a configuration can provide a molding material that includes cellulose fibers, is excellent in both impact strength and bending strength, and can be suitably used for producing a molded body with dust generation suppressed.

Such excellent effects are considered to be obtained for the following reasons. That is, by virtue of including cellulose, which has theoretically high strength and is excellent in shape retainability, and a binder as well as including urethane which has excellent compatibility and affinity with the cellulose fibers and the binder, functions of these components are prevented and inhibited from being cancelled, and the functions of these components can be sufficiently exerted. More specifically, wettability of the binder against the cellulose fibers can be enhanced while sufficiently exerting the functions of the cellulose fibers and the binder, and boundary separation between different components constituting a molded body can be suitably prevented and suppressed, during production of a molded body using the molding material or in a molded body produced by using the molding material. As a result, the excellent effects as described above are considered to be obtained. In addition, since boundary separation between different components constituting a molded body can be suitably prevented and suppressed, a molded body in which the problem of dust generation or the like is effectively prevented can be obtained.

In addition, by virtue of including cellulose fibers, which are abundant natural material derived from a plant, environmental problems, saving of underground resources, and the like can be suitably addressed, and inclusion of cellulose fibers is advantageous also from the viewpoints of stable supply of the molding material and a molded body produced by using same, reduction in costs, and the like. Cellulose fibers are also a component contained in, for example, used paper, used fabric, and the like besides virgin pulp in a large amount and are advantageous also from the viewpoint of facilitating effective reusing of resources.

Meanwhile, urethane fibers are contained in used clothing and the like in a large amount, but are difficult to isolate from other components when urethane fibers are mixed with the other components as in blended fabric, for example. In addition, urethane fibers generate toxic gas during heating treatment at 200° C. or higher and thus have been difficult to reuse and difficult to subject to incineration disposal in the past. However, urethane fibers included in used clothing and the like can be suitably reused according to the present disclosure.

On the other hand, when the above-described conditions are not satisfied, sufficient results cannot be obtained. For example, even when cellulose fibers and a binder are included, without including urethane, wettability of the binder against the cellulose fibers cannot be made sufficiently excellent, boundary separation between different components easily occurs in a molded body produced by using the molding material, and strength of the molded body cannot be sufficiently made excellent. In addition, a problem of dust generation is likely to arise in a molded body produced by using such a molding material.

Furthermore, even when cellulose fibers and urethane fibers are included, without including a binder, moldability of a molded body significantly decreases, and production of the molded body itself becomes difficult.

Furthermore, even when a binder and urethane fibers are included, without including cellulose fibers, the above-described effects provided by including cellulose fibers are not exerted, and strength of a molded body produced by using such a molding material is significantly decreased.

### [1-1] Cellulose Fibers

The molding material of the present disclosure includes cellulose fibers.

The cellulose fibers are a component which greatly contributes to retention of the shape of a molded body produced by using the molding material of the present disclosure and which greatly affects characteristics of the molded body such as strength.

Cellulose is abundant natural material derived from a plant. Therefore, environmental problems, saving of underground resources, and the like can be suitably addressed by using the cellulose fibers, and use of cellulose is advantageous also from the viewpoints of stable supply of the molding material and a molded body produced by using same, reduction in costs, and the like. In addition, the cellulose fibers have especially high theoretical strength among various types of fibers and are advantageous also from the viewpoint of enhancing strength of a molded body.

Virgin pulp may be used, or used paper, used fabric, and the like may be reused, as the cellulose fibers.

The cellulose fibers are usually composed mainly of cellulose but may include a component other than cellulose. Examples of such a component include hemicellulose and lignin.

Cellulose fibers having been subjected to treatment such as bleaching may be used as the cellulose fibers. Examples of the cellulose fibers include cotton, linen, rayon, and cupra.

The average length of the cellulose fibers is not particularly limited but is preferably less than 3 mm, more preferably 50 μm or more and less than 500 μm, and still more preferably 100 μm or more and less than 400 μm.

Shape stability, strength, and the like of a molded body produced by using the molding material can be made more excellent thereby. In addition, dust generation in a molded body produced by using the molding material can be more effectively prevented and suppressed. In addition, generation of unwilling irregularities on a surface of a molded body produced by using the molding material can be more effectively prevented. Incidentally, the fiber length is obtained by a method in accordance with ISO 16065-2:2007.

The average diameter of the cellulose fibers is not particularly limited but is preferably less than 100 μm, more preferably 3 μm or more and less than 50 μm, and still more preferably 5 μm or more and less than 20 μm.

Shape stability, strength, and the like of a molded body produced by using the molding material can be made more excellent thereby. In addition, generation of unwilling irregularities on a surface of a molded body produced by using the molding material can be more effectively prevented.

The average aspect ratio, that is, the ratio of the average length to the average diameter of the cellulose fibers is not particularly limited but is preferably 10 or more and 1000 or less, and more preferably 15 or more and 100 or less.

Shape stability, strength, and the like of a molded body produced by using the molding material can be made more excellent thereby. In addition, dust generation in a molded body produced by using the molding material can be more effectively prevented and suppressed. In addition, generation of unwilling irregularities on a surface of a molded body produced by using the molding material can be more effectively prevented.

The content of the cellulose fibers in the molding material of the present disclosure is preferably 2% by mass or more and 40% by mass or less, more preferably 3% by mass or more and 35% by mass or less, and still more preferably 5% by mass or more and 30% by mass or less.

The above-described effects provided by the present disclosure are significantly exerted thereby. In addition, moldability of a molded body is made more excellent, which is advantageous for improving productivity of the molded body.

### [1-2] Binder

The molding material of the present disclosure includes a binder.

When the binder is included, toughness of a molded body produced by using the molding material of the present disclosure can be enhanced, and impact resistance of the molded body can be made sufficiently excellent.

Although any binders may be used as long as they can exert the above-described function, the binder is usually a resin material.

Examples of the resin material as the binder, that is, examples of binder resin include polyolefins such as polyethylene and polypropylene and polyesters such as an aliphatic polyester and an aromatic polyester. One kind or a combination of two or more kinds selected therefrom can be used, and at least one kind of polyolefins and aliphatic polyesters is preferable.

Consequently, affinity between the binder and urethane can be made more excellent, and the above-described effects are more significantly exerted.

An aliphatic polyester is a polyester having no aromatic chemical structure and is a polyester in which all constituent monomers have no aromatic chemical structure. Examples of the aliphatic polyester include those in which each of the polycarboxylic acid component and the polyhydric alcohol component as constituent monomers has an aliphatic alkylene group. The aliphatic polyester may be composed of a monomer having a hydroxy group and carboxy group within a molecule. Examples of the aliphatic polyester composed of a monomer having a hydroxy group and carboxy group within a molecule include polylactic acid.

When the aliphatic polyester has a chemical structure in which a polycarboxylic acid component having an aliphatic alkylene group and a polyhydric alcohol component having an aliphatic alkylene group are polymerized, the aliphatic polyester preferably has a chemical structure in which an alkylene dicarboxylic acid having an alkylene group with a carbon chain length of 2 or more and 6 or less and an alkylene diol having an alkylene group with a carbon chain length of 2 or more and 8 or less are condensed.

Consequently, the function as the binder can be more effectively exerted, compatibility with urethane can be made more excellent, and the above-described effects are more significantly exerted.

The carbon chain length of the alkylene group included in the alkylene dicarboxylic acid is preferably 2 or more and 6 or less, more preferably 2 or more and 5 or less, and still more preferably 2 or more and 4 or less. The above-described effects are more significantly exerted thereby.

The alkylene group included in the alkylene dicarboxylic acid may have a branched structure but is preferably linear. The above-described effects are more significantly exerted thereby.

Examples of the alkylene dicarboxylic acid include succinic acid, glutaric acid, adipic acid, pimelic acid, suberic acid, azelaic acid, and sebacic acid, and one kind or a combination of two or more kinds selected therefrom can be used.

The carbon chain length of the alkylene group included in the alkylene diol acid is preferably 2 or more and 8 or less, more preferably 2 or more and 6 or less, and still more preferably 3 or more and 5 or less. The above-described effects are more significantly exerted thereby.

The alkylene group included in the alkylene diol may have a branched structure but is preferably linear. The above-described effects are more significantly exerted thereby.

Examples of the alkylene diol include 1,2-ethanediol, 1,3-propanediol, 1,4-butanediol, 1,5-pentanediol, 1,6-hexanediol, 1,7-heptanediol, and 1,8-octanediol, and one kind or a combination of two or more kinds selected therefrom can be used.

Specific examples of the aliphatic polyester including, as monomer components, an alkylene dicarboxylic acid and an alkylene diol satisfying the above requirements include polybutylene succinate, polybutylene succinate adipate, and polyethylene adipate, and one kind or a combination of two or more kinds selected therefrom can be used. Among them, polybutylene succinate, polybutylene succinate adipate, and polyethylene adipate are preferable.

These materials have biodegradability and can more suitably reduce the environmental burden of molded products. In addition, these materials are relatively inexpensive and easily available in a stable manner. Accordingly, these materials are advantageous also from the viewpoints of stable supply of the molding material and a molded body thereof, cost reduction, and the like.

The content of the binder in the molding material of the present disclosure is not particularly limited but is preferably 35% by mass or more and 94% by mass or less, more preferably 40% by mass or more and 92% by mass or less, and still more preferably 50% by mass or more and 90% by mass or less. The above-described effects provided by the present disclosure are more significantly exerted thereby.

When the content of the cellulose fibers and the content of the binder in the molding material of the present disclosure are denoted as XC [mass %] and XB [mass %], respectively, the relation therebetween satisfies preferably 0.01≤XC/XB≤0.60, more preferably 0.02≤XC/XB≤0.50, and still more preferably 0.03≤XC/XB≤0.45. The above-described effects provided by the present disclosure are more significantly exerted thereby.

### [1-3] Urethane Fibers

The molding material of the present disclosure includes urethane fibers. The urethane fibers are composed of a material including urethane.

The urethane fibers usually melt during the process of producing a molded body using the molding material of the present disclosure, especially during heat treatment in molding.

Urethane is a component having excellent affinity with both of the cellulose fibers and the binder described above.

Such urethane functions as a compatibilizing agent when a molded body is produced using the molding material of the present disclosure and improves compatibility between the cellulose fibers and the binder. Consequently, wettability of the binder against the cellulose fibers is enhanced, and bending strength of a molded body produced by using the molding material of the present disclosure can be improved. In addition, heat resistance of a molded body produced by using the molding material of the present disclosure can be also improved by including the binder.

Urethane constituting the urethane fibers may be a compound obtained through reaction of an amino group and an alcohol group via a carbonyl group to form a new covalent bond between nitrogen of the amine and carbon of the carbonyl group, but is preferably a polyurethane.

When the urethane fibers are composed of a material including a polyurethane, the number average molecular weight of the polyurethane is preferably 20000 or more and 300000 or less, more preferably 30000 or more and 200000 or less, and still more preferably 40000 or more and 150000 or less.

Consequently, affinity and compatibility of the polyurethane with the cellulose fibers and the binder can be made more excellent, and impact strength and bending strength of a molded body produced by using the molding material can be made more excellent.

The urethane fibers are fibrous in the molding material of the present disclosure, but part thereof may be powdery or in a melted state, for example.

The average length of the urethane fibers is not particularly limited but is preferably less than 3 mm, more preferably 50 μm or more and less than 500 μm, and still more preferably 100 μm or more and less than 400 μm.

Impact strength and bending strength of a molded body produced by using the molding material can be made more excellent thereby.

The average diameter of the urethane fibers is not particularly limited but is preferably less than 100 μm, more preferably 3 μm or more and less than 50 μm, and still more preferably 5 μm or more and less than 20 μm.

Impact strength and bending strength of a molded body produced by using the molding material can be made more excellent thereby.

The average aspect ratio, that is, the ratio of the average length to the average diameter of the urethane fibers is not particularly limited but is preferably 10 or more and 1000 or less, and more preferably 15 or more and 100 or less.

Impact strength and bending strength of a molded body produced by using the molding material can be made more excellent thereby.

The content of the urethane fibers in the molding material of the present disclosure is preferably 2% by mass or more and 40% by mass or less, more preferably 3% by mass or more and 35% by mass or less, and still more preferably 5% by mass or more and 30% by mass or less.

Impact strength and bending strength of a molded body produced by using the molding material can be made more excellent thereby.

When the content of the binder and the content of the urethane fibers in the molding material of the present disclosure are denoted as XB [mass %] and XU [mass %], respectively, the relation therebetween satisfies preferably 0.01≤XU/XB≤0.60, more preferably 0.02≤XU/XB≤0.50, and still more preferably 0.03≤XU/XB≤0.45.

Impact strength and bending strength of a molded body produced by using the molding material can be made more excellent thereby.

When the content of the cellulose fibers and the content of the urethane fibers in the molding material of the present disclosure are denoted as XC [mass %] and XU [mass %], respectively, the relation therebetween satisfies preferably 0.2≤XU/XC≤5.0, more preferably 0.3≤XU/XC≤3.0, and still more preferably 0.4≤XU/XC≤2.5.

Impact strength and bending strength of a molded body produced by using the molding material can be made more excellent thereby.

### [1-4] Other Fibers

The molding material of the present disclosure may further include fibers other than the cellulose fibers and the urethane fibers. Hereinafter, such fibers are also referred to as “other fibers.”

When the other fibers are included, the other fibers function as a filler with wettability close to that of the binder. Therefore, inclusion of the other fibers is advantageous to further enhance strength of a molded body.

Examples of the other fibers include polyester fibers, acrylic fibers, nylon fibers, and acetate fibers.

The average length of the other fibers is not particularly limited but is preferably less than 3 mm, more preferably 50 μm or more and less than 500 μm, and still more preferably 100 μm or more and less than 400 μm.

Impact strength and bending strength of a molded body produced by using the molding material can be made more excellent thereby.

The average diameter of the other fibers is not particularly limited but is preferably less than 100 μm, more preferably 3 μm or more and less than 50 μm, and still more preferably 5 μm or more and less than 20 μm.

Impact strength and bending strength of a molded body produced by using the molding material can be made more excellent thereby.

The average aspect ratio, that is, the ratio of the average length to the average diameter of the other fibers is not particularly limited but is preferably 10 or more and 1000 or less, and more preferably 15 or more and 100 or less.

Impact strength and bending strength of a molded body produced by using the molding material can be made more excellent thereby.

The content of the other fibers in the molding material of the present disclosure is preferably 1% by mass or more and 30% by mass or less, more preferably 2% by mass or more and 25% by mass or less, and still more preferably 3% by mass or more and 20% by mass or less.

Impact strength and bending strength of a molded body produced by using the molding material can be made more excellent thereby.

When the content of the binder and the content of the other fibers in the molding material of the present disclosure are denoted as XB [mass %] and XO [mass %], respectively, the relation therebetween satisfies preferably 0.01≤XO/XB≤0.45, more preferably 0.02≤XO/XB≤0.36, and still more preferably 0.03≤XO/XB≤0.30.

Impact strength and bending strength of a molded body produced by using the molding material can be made more excellent thereby.

When the content of the cellulose fibers and the content of the other fibers in the molding material of the present disclosure are denoted as XC [mass %] and XO [mass %], respectively, the relation therebetween satisfies preferably 0.1≤XO/XC≤3.8, more preferably 0.2≤XO/XC≤2.1, and still more preferably 0.3≤ XO/XC≤1.7.

Impact strength and bending strength of a molded body produced by using the molding material can be made more excellent thereby.

### [1-5] Flame Retardant

The molding material of the present disclosure may further include a flame retardant.

Examples of the flame retardant include an inorganic flame retardant such as an antimony compound, a metal hydroxide, a nitrogen compound, and a boron compound; and an organic flame retardant such as a bromine compound and a phosphorus compound.

In the case where the molding material includes the flame retardant, the content of the flame retardant can be 1 part by mass or more and 20 parts by mass or less when the content of the total of the cellulose fibers, the binder, and the urethane fibers is taken as 100 parts by mass.

Consequently, flame retardancy of a molded body produced by using the molding material of the present disclosure can be made more excellent while more effectively exerting the above-described effects of the present disclosure.

### [1-6] Other Components

The molding material of the present disclosure may include components other than those described above. Hereinafter, such components are also referred to as the “other components” in this section.

Examples of the other components include a colorant, an insect repellent, a fungicide, an antioxidant, an ultraviolet absorber, an aggregation inhibitor, a mold release agent, and a resin material other than those described above.

The content of the other components in the molding material of the present disclosure is preferably 10% by mass or less, more preferably 5% by mass or less, and still more preferably 3% by mass or less.

### [2] Molding Material Production Method

Next, a molding material production method of the present disclosure will be described.

The molding material of the present disclosure can be produced by mixing the above-described components, for example. In this case, timings for mixing the respective components may be identical or different from one another.

The molding material of the present disclosure may be produced by kneading the above-described components, for example. The compatibilizing effect of urethane is effectively exerted thereby. A monoaxial kneader or a biaxial kneader may be used for kneading each component, for example.

The molding material having a strand shape obtained through kneading may be subjected to pelletizing using a strand pelletizer, a watering hot cut pelletizer, or the like to be made into a pellet molding material, for example.

The following method may be applied as the molding material production method. That is, a kneaded mixture of the above-described components may be molded into a sheet shape and subsequently cut into a desired shape using, for example, a shredder to form a pellet-shaped molding material. Although the method for molding the kneaded mixture into a sheet shape is not particularly limited, examples thereof include a method in which the kneaded mixture is firstly accumulated in air to obtain sheet-shaped deposits, and the deposits are compressed by a calendar device to eliminate air and increase density, followed by heating in a non-contact manner using a heating furnace and subsequent heat-pressing with a heat-pressing device. The shape and the size of the pellet obtained by cutting are not particularly limited but may be an approximately cuboid shape with a side length of 2 mm or more and 5 mm or less, for example.

The cellulose fibers used to produce the molding material of the present disclosure may be preliminarily subjected to defibrination processing. In particular, a material obtained by defibrinating a cellulose fiber source including cellulose fibers such as used paper and used fabric may be used.

The urethane fibers used to produce the molding material of the present disclosure may be preliminarily subjected to defibrination processing. In particular, a material obtained by defibrinating a urethane fiber source including urethane fibers such as used fabric may be used.

When the molding material of the present disclosure includes other fibers, the other fibers used to produce the molding material of the present disclosure may be preliminarily subjected to defibrination processing. In particular, a material obtained by defibrinating a source of the other fibers including the other fibers such as used fabric may be used.

The fiber sources described above, that is, the cellulose fiber source, the urethane fiber source, the source of the other fibers may be coarsely pulverized before defibrination.

The fiber sources can be coarsely pulverized by shredding the fiber sources into strips in, for example, an atmosphere such as atmospheric air using a shredder having a coarsely pulverizing blade. The shape of the strips is, for example, an approximately cuboid shape or approximately cube shape with a side length of several millimeters.

The strips of the fiber sources are defibrinated to obtain defibrinated fibers. The term defibrination herein refers to loosening of fibers into a single fiber from a state where multiple fibers are integrated.

Defibrination can be preferably carried out under a dry-manner condition. The dry-manner herein is a manner in which defibrination is carried out in a gas such as atmospheric air not in a liquid. Water or the like may be sprayed into fibers for the purpose of prevention of static charge or the like, for example. Defibrination in a dry manner can be preferably carried out by an air flow, for example.

Defibrination of the fiber sources may be independently carried out for each of the fiber sources or may be carried out in a state where multiple kinds of the fiber sources are mixed.

A fiber source including multiple kinds of fibers, more specifically, two or more kinds of the cellulose fibers, the urethane fibers, and the other fibers may be used. Examples of the fiber source including two or more kinds of fibers include blended fabric.

Defibrination of the fiber sources may be carried out in a state of including a component other than fibers, for example, a binder, a flame-retardant, another component, and the like.

### [3] Molded Body

Next, a molded body produced by using the molding material of the present disclosure will be described.

The molded body according to the present disclosure includes cellulose fibers, a binder, and urethane fibers. The molded body according to the present disclosure can be produced by using the molding material described above.

A molded body which includes cellulose fibers and is excellent in both impact strength and bending strength and in which dust generation is suppressed can be provided thereby.

In addition, by virtue of including cellulose fibers, which are abundant natural material derived from a plant, environmental problems, saving of underground resources, and the like can be suitably addressed, and inclusion of cellulose fibers is advantageous also from the viewpoints of stable supply of the molded body, reduction in costs, and the like. Cellulose fibers are also a component contained in, for example, used paper, used fabric, and the like besides virgin pulp in a large amount and are advantageous also from the viewpoint of facilitating effective reusing of resources.

Meanwhile, urethane fibers are contained in used clothing and the like in a large amount, but are difficult to isolate from other components when urethane fibers are mixed with the other components as in blended fabric, for example. In addition, urethane fibers generate toxic gas during heating treatment at 200° C. or higher and thus have been difficult to reuse and difficult to subject to incineration disposal in the past. However, urethane fibers included in used clothing and the like can be suitably reused according to the present disclosure.

The respective components constituting the molded body preferably satisfy the requirements described in items [1-1] to [1-6] above.

The shape of the molded body is not particularly limited but may be any shape such as a sheet shape, a block shape, a spherical shape, a three-dimensional shape, for example.

The molded body is used for any application but can be suitably applied to those used in an environment in which dust generation or the like is problematic, more specifically, to a member having a fluid path, a member disposed around such a member, an ink cartridge, various containers, and various fixtures, for example. A molded body produced by using an existing material including cellulose fibers and a resin has have the problem of easily causing dust generation and has have the problem of unsuitable for those used in an environment in which dust generation or the like as described above is problematic. On the other hand, the molded body according to the present disclosure hardly generates dust. Accordingly, the effects of the present disclosure are more significantly excreted when the molded body according to the present disclosure is applied for application described above.

### [4] Molded Body Production Method

Next, a molded body production method according to the present disclosure will be described.

The molded body according to the present disclosure can be preferably produced by molding the molding material through various molding methods such as injection molding and press molding, while heating the molding material, for example.

The temperature at which the molding material is heated during molding is not particularly limited but is preferably less than 200° C., more preferably 120° C. or more and 190° C. or less, and still more preferably 150° C. or more and 180° C. or less.

Post-treatment such as machine processing like grinding and polishing, coating, and plating may be carried out after molding described above, for example.

Hereinbefore, preferable embodiments of the present disclosure are described, but the present disclosure is not limited thereto.

### EXAMPLES

Next, specific examples of the present disclosure will be described.

### [5] Preparation of Molding Material

### Example 1

First, collected market clothing including cellulose fibers, urethane fibers, polyester fibers, and acrylic fibers was prepared as a fiber source.

This fiber source was shredded, in atmospheric air, using a shredder having a coarsely pulverizing teeth into an approximately cube shape with a side length of several millimeters, subsequently blown with an air flow, and defibrinated.

The proportions of the cellulose fibers, the urethane fibers, the polyester fibers, and the acrylic fibers in the obtained defibrinated product was 3.0:3.0:2.0:2.0 in terms of mass ratio.

Amounts of 10.0 parts by mass of the defibrinated product obtained as described above and 90.0 parts by mass of polypropylene (manufactured by Prime Polymer Co., Ltd., H700) as a binder were weighed. Thereafter, the weighed defibrinated product and polypropylene were put into a biaxial kneader (manufactured by TECHNOVEL CORPORATION, KZW15TW-45MG) and kneaded. As kneading conditions, the highest heating temperature was set to 180° C., and the extrusion discharging amount was set to 1 kg/hr. Then, the kneaded product was processed into a strand shape, and a molding material having a pellet shape was then obtained using a pelletizer.

The average length of the cellulose fibers was 1.5 mm, the average diameter of the cellulose fibers was 15 μm, the average length of the urethane fibers was 1.5 mm, the average diameter of the urethane fibers was 50 μm, and the number average molecular weight of polyurethane constituting the urethane fibers was 60000 in the molding material.

### Examples 2 to 7

Pellet-shaped molding materials were prepared in the same manner as in Example 1 described above except that the types and use amounts of the raw materials were changed so that the compositions of the molding materials shown in Table 1 were achieved.

### Comparative Examples 1 to 8

Pellet-shaped molding materials were prepared in the same manner as in Example 1 described above except that the types and use amounts of the raw materials were changed so that the compositions of the molding materials shown in Table 1 were achieved.

### [6] Production of Molded Bodies

Each of the molding materials in Examples and Comparative Examples was injection-molded using an injection molding machine (manufactured by NISSEI PLASTIC INDUSTRIAL CO., LTD., THX40-5V) to produce a molded body for Charpy impact strength evaluation and a molded body for bending strength evaluation, bending elastic modulus evaluation, and generated dust particle number evaluation described later. The temperature for heating the molding material during injection molding was set to 180° C. The molded body for Charpy impact strength evaluation was a rectangular plate-shaped molded body having a longer side length of 80 mm±2 mm, a shorter side length of 4.0 mm±0.2 mm, and a thickness of 10.0 mm±0.2 mm, and the molded body for bending strength evaluation, bending elastic modulus evaluation, and generated dust particle number evaluation was a rectangular plate-shaped molded body having a longer side length of 80 mm±2 mm, a shorter side length of 10.0 mm±0.2 mm, and a thickness of 4.0 mm±0.2 mm.

### [7] Evaluation

The molded bodies of each of Examples and Comparative Examples were subjected to the following evaluations.

### [7-1] Charpy Impact Strength

Charpy impact strength was measured in accordance with ISO 179 (JIS K7111) using an impact tester IT manufactured by Toyo Seiki Seisaku-sho, Ltd. for each of the molded bodies for Charpy impact strength evaluation of Examples and Comparative Examples produced as described in item [6] above. In Charpy impact strength measurement, the hummer weight was 4 J (WR 2.14 N/m), the raising angle was 150°, the remaining notch width was 8.0 mm±0.2 mm, and the notch angle was 45°.

### [7-2] Bending Strength

Bending strength was measured in accordance with ISO 178 (JIS K7171) using 68TM-30 manufactured by Instron for each of the molded bodies for bending strength evaluation of Examples and Comparative Examples produced as described in item [6] above. In bending strength measurement, the distance between fulcrums was 64 mm.

### [7-3] Bending Elastic Modulus

The bending elastic modulus was measured in accordance with ISO 178 (JIS K7171) using 68TM-30 manufactured by Instron for each of the molded bodies for bending elastic modulus evaluation of Examples and Comparative Examples produced as described in item [6] above. In bending elastic modulus measurement, the distance between fulcrums was 64 mm.

### [7-4] Generated Dust Particle Number

The Charpy impact strength test described in item [7-1] above was repeated 10 times for each of the molded bodies for generated dust particle number evaluation of Examples and Comparative Examples produced as described in item [6] above, the number of particles within a neighboring region with a radius of 10 cm around the hit point of the tester was measured and compared with a value before conducting the test. The case where the total amount of dust generated was 20% or less with respect to the initial value was rated as “good,” and the case where the total amount of dust generated exceeded 20% with respect to the initial value was rated as “poor.” Incidentally, fractions in the order of millimeters beyond the measurement range of a particle counter were exempted, assuming a use environment such as a printer head or a sensor.

### [7-5] Comprehensive Evaluation

From the measurement result of the Charpy impact strength in item [7-1] above, the measurement result of the bending elastic modulus in item [7-3] above, and the measurement result of the number of generated dust particles in item [7-4] above, comprehensive evaluation was carried out according to the following criteria for each of Examples and Comparative Examples.
A: The Charpy impact strength was 2.5 kJ/m² or more, the bending elastic modulus was 1.5 GPa or more, and the number of generated dust particles was less than 5.
B: While one requirement of the two requirements “the Charpy impact strength of 2.5 KJ/m² or more” and “the bending elastic modulus of 1.5 GPa or more” was satisfied, the other requirement was not satisfied, and the number of generated dust particles was less than 5.
C: The Charpy impact strength was less than 2.5 KJ/m², the bending elastic modulus was less than 1.5 GPa, and the number of generated dust particles was less than 5.
D: The number of generated dust particles was 5 or more.

These results are summarized and shown in Table 1 together with the compositions of the respective molding materials obtained in Examples and Comparative Examples. In Table 1, polypropylene (manufactured by Prime Polymer Co., Ltd., H700) as the binder is denoted as “polypropylene,” polyethylene (manufactured by Prime Polymer Co., Ltd., 2208J) as the binder is denoted as “polyethylene,” polylactic acid (manufactured by UNITIKA LTD., TERRAMAC TE-2000) as the binder is denoted as “polylactic acid,” polybutylene succinate (manufactured by Mitsubishi Chemical Corporation, BioPBS FZ71PB) as the binder is denoted as “polybutylene succinate,” METABLEN P-1901 manufactured by Mitsubishi Chemical Corporation was denoted as “additive 1,” and MG-670P manufactured by Riken Vitamin Co., Ltd. was denoted as “additive 2,” and ES-A60NX manufactured by ARONKASEI CO., LTD. was denoted as “elastomer agent.”

| | | | | | | | | | | Comparative |
|---|---|---|---|---|---|---|---|---|---|---|
| | | | Examples | | | | | | | Examples |
| | | | 1 | 2 | 3 | 4 | 5 | 6 | 7 | 1 |
| Composition | Binder | Polypropylene | 90.0 | — | — | 60.0 | 60.0 | — | — | 100.0 |
| [mass part] | | Polyethylene | — | 70.0 | 70.0 | — | — | — | — | — |
| | | Polylactic acid | — | — | — | — | — | 50.0 | — | — |
| | | Polybutylene | — | — | — | — | — | — | 50.0 | — |
| | | succinate | | | | | | | | |
| | Urethane fiber | | 3.0 | 8.0 | 8.0 | 20.0 | 20.0 | 10.0 | 20.0 | — |
| | Cellulose | Cotton fiber | — | — | — | 10.0 | 10.0 | 20.0 | 20.0 | — |
| | fiber | Rayon fiber | 3.0 | 8.0 | 8.0 | — | — | — | — | — |
| | Other fiber | Polyester fiber | 2.0 | 7.0 | 7.0 | — | 10.0 | 10.0 | 5.0 | |
| | | Acrylic fiber | 2.0 | 7.0 | 7.0 | 10.0 | — | 10.0 | 5.0 | — |
| | Other | Additive 1 | — | — | 5.0 | — | — | — | — | — |
| | component | Additive 2 | — | — | — | 5.0 | — | — | — | — |
| | | Elastomer agent | — | — | — | — | 5.0 | — | — | — |

| | | | | | | | | | |
|---|---|---|---|---|---|---|---|---|---|
| Evaluation | Charpy impact strength [kJ/m²] | 2.5 | 2.0 | 3.0 | 4.5 | 5.5 | 2.5 | 4.0 | 5.0 |
| | Bending strength [MPa] | 40 | 35 | 45 | 30 | 27 | 100 | 45 | 20 |
| | Bending elastic modulus [GPa] | 1.5 | 2.5 | 2.5 | 2.0 | 1.8 | 6.5 | 3.5 | 0.9 |
| | Generated dust number | Good | Good | Good | Good | Good | Good | Good | Good |
| | Comprehensive evaluation | A | B | A | A | A | A | A | B |

| | | | Comparative Examples | | | | | | |
|---|---|---|---|---|---|---|---|---|---|
| | | | 2 | 3 | 4 | 5 | 6 | 7 | 8 |
| Composition | Binder | Polypropylene | — | — | — | 70.0 | 55.0 | 50.0 | — |
| [mass part] | | Polyethylene | 100.0 | — | — | — | — | — | 60.0 |
| | | Polylactic acid | — | 100.0 | — | — | — | — | — |
| | | Polybutylene | — | — | 100.0 | — | — | — | — |
| | | succinate | | | | | | | |

| Urethane fiber | | — | — | — | — | — | — | — |
|---|---|---|---|---|---|---|---|---|
| Cellulose | Cotton fiber | — | — | — | 10.0 | — | 40.0 | — |
| fiber | Rayon fiber | — | — | — | — | 25.0 | — | 20.0 |
| Other fiber | Polyester fiber | | | | 20.0 | 20.0 | 8 | 10.0 |
| | Acrylic fiber | — | — | — | — | — | — | 10.0 |
| Other | Additive 1 | — | — | — | — | — | — | — |
| component | Additive 2 | — | — | — | — | — | — | — |
| | Elastomer agent | — | — | — | — | — | — | — |

| | | | | | | | | |
|---|---|---|---|---|---|---|---|---|
| Evaluation | Charpy impact strength [kJ/m²] | 6.9 | 2.0 | 7.0 | 1.0 | 0.8 | 0.5 | 0.5 |
| | Bending strength [MPa] | 30 | 75 | 30 | 35 | 15 | 20 | 15 |
| | Bending elastic modulus [GPa] | 1.2 | 4.0 | 0.6 | 2.0 | 3.0 | 4.0 | 4.0 |
| | Generated dust number | Good | Good | Good | Poor | Poor | Poor | Poor |
| | Comprehensive evaluation | B | B | B | D | D | D | D |

As clear from Table 1, excellent results were obtained from each of Examples. On the other hand, no sufficient result was obtained from each of Comparative Examples.

In addition, a molding material was produced in the same manner as Examples described above except that the average length of the cellulose fibers was 50 μm or more and less than 3 mm, the average diameter of the cellulose fibers was 3 μm or more and less than 100 μm, the average length of the urethane fibers was 50 μm or more and less than 3 mm, the average diameter of the urethane fibers was 3 μm or more and less than 100 μm, and the number average molecular weight of the polyurethane constituting the urethane fibers was 20000 or more 300000 or less in the molding material, and the same evaluations as those described above were conducted thereon to obtain results similar to those described above.

What is claimed is:

1. A molding material comprising: cellulose fibers, a binder, and urethane fibers.

2. The molding material according to claim 1, wherein
a content of the cellulose fibers is 2% by mass or more and 40% by mass or less.

3. The molding material according to claim 1, wherein
an average length of the cellulose fibers is less than 3 mm.

4. The molding material according to claim 1, wherein
an average diameter of the cellulose fibers is less than 100 μm.

5. The molding material according to claim 1, wherein
a content of the binder is 35% by mass or more and 94% by mass or less.

6. The molding material according to claim 1, wherein
a content of the urethane fibers is 2% by mass or more and 40% by mass or less.
